(19) United States
(12) Patent Application Publication
(10) Pub. No.: US 2020/0134516 A1
(43) Pub. Date: Apr. 30, 2020

(54) METHOD FOR ASSET MANAGEMENT OF ELECTRIC POWER EQUIPMENT

(71) Applicant: HYOSUNG HEAVY INDUSTRIES CORPORATION, Seoul (KR)

(72) Inventors: Eun Tae LYU, Changwon-si, Gyeongsangnam-do (KR); Jae Ryong JUNG, Gimhae-si, Gyeongsangnam-do (KR); Hwang Dong SEO, Gimhae-si, Gyeongsangnam-do (KR)

(21) Appl. No.: 16/608,112

(22) PCT Filed: Apr. 26, 2018
(86) PCT No.: PCT/KR2018/004868

§ 371 Date: Oct. 24, 2019

(30) Foreign Application Priority Data
Apr. 28, 2017 (KR) 10-2017-0055657

(51) Int. Cl. G06Q 10/06; G06Q 50/06; G06Q 10/00; G05B 23/02; G06Q 10/04

(52) U.S. Cl. CPC G06Q 10/06; G06Q 50/06; G06Q 10/04; G05B 23/0283; G06Q 10/20

(57) ABSTRACT

A method for asset management of power equipment compensates a reference reliability model by each sub-device of the power equipment and generate a unique reliability model by the each sub-device by comparing reliability of the reference reliability model by the each sub-device and the health index by the each sub-device; assesses priorities based on equipment sensitivity and establishes a maintenance strategy while analyzing reliability by substation system reliability and reliability by economic value; calculates reliability of the power equipment by applying a system relationship model between the power equipment and the each sub-device to which specific weight and failure rate are reflected; selects a maintenance scenario by a predetermined priority; and updates the reliability model for the power equipment and the unique reliability model by the each sub-device as a result of executing maintenance.

### FIELD OF THE INVENTION

The present invention relates to a method for asset management of power equipment and an apparatus for executing this; and more particularly to, the method for asset management of power equipment capable of deriving an optimized management plan by power equipment depending on health index of each sub-device of which the power equipment is composed and the apparatus for executing this.

### BACKGROUND OF THE INVENTION

Among power systems, a transmission system or a distribution system has a substation to raise or reduce output of a generator or voltage of the system. In addition to a transformer for raising or reducing voltage, the substation includes devices or systems for centralizing or distributing power, those for controlling tidal current, or those for protecting and controlling its devices.

For example, in a gas circuit breaker used for a gas insulated switchgear or GIS, a gas pressure sensor for detecting gas pressure change, current and voltage detectors, etc. are installed while a transformer has a thermometer, a pressure gauge, a liquid measuring sensor, a current detector, etc. as sensors for detecting its state.

Those sensors are connected to a protective system, a measuring system, a controller, and a devices-monitoring system through cables which transmit electronic signals. Again, the protective system, the measuring system, the controller, and the devices-monitoring system are connected to a superior substation-monitoring controller through cables which transmit the electronic signals.

The substation has very complicated equipment to stably supply electricity which monitors operational state of a variety of devices such as a circuit breaker installed in the substation and also provides a monitoring system to detect a failure symptom in advance to prevent, or recover from, such failure in rapid response to any incurred failure.

As it is difficult to identify accurate states of elements of the substation, the need for optimized techniques for asset management, such as an element replacement cycle, and a maintenance plan, is raised and a plan for solving such requirements is needed.

### DETAILED EXPLANATION OF THE INVENTION

### Objects of the Invention

An object of the present invention is to provide a method of being capable of selecting an optimal maintenance scenario based on assessing system reliability index and economic efficiency.

Another object of the present invention is to provide a method for asset management of power equipment to derive an optimal reliability model of the power equipment by compensating a reliability model of the power equipment while being allowed to derive an optimal reliability model by sub-device of the power equipment through a process of compensating a pre-generated reliability model of the power equipment and an apparatus for executing this.

The other object of the present invention is to provide a method for asset management of power equipment to satisfy needs of customers for requests of a replacement cycle, a maintenance plan, and an asset management technique of the power equipment and its sub-devices and an apparatus for executing this.

The objects of the present invention are not limited to the aforementioned objects and other objects which have not been mentioned could be clearly understood by those skilled in the art from description below.

### Means of Solving the Problem

A method for asset management of power equipment in accordance with the present invention comprises steps of: generating health index of each sub-device of the power equipment by using state data and real-time monitoring data of the each sub-device; compensating a reference reliability model by the each sub-device and generating a unique reliability model by the each sub-device by comparing reliability of the reference reliability model by the each sub-device and the health index by the each sub-device; analyzing reliability by substation system reliability and reliability by economic value; assessing priorities based on equipment sensitivity and establishing a maintenance strategy; calculating reliability of the power equipment by applying a system relationship model between the power equipment and the each sub-device to which specific weight and failure rate are reflected; deriving, and calculating a quotation of, a maintenance scenario by the each sub-device; selecting a maintenance scenario by predetermined priorities, confirming whether to execute the maintenance, and updating the unique reliability model by the each sub-device, thereby updating the reliability model for the power equipment as a result of executing the maintenance.

Detailed matters of other example embodiments are included in detailed explanation and attached drawings.

### Effects of the Invention

The present invention has an advantage of being capable of selecting an optimal maintenance scenario based on result of assessing system reliability index and economic efficiency.

The present invention has an advantage of being capable of deriving an optimal reliability model by compensating a reference reliability model of the power equipment while deriving an optimal reliability model by sub-device of power equipment during a process of compensating the pre-generated reference reliability model by sub-device thereof.

Besides, the present invention has an advantage of satisfying needs of customers for requests of a replacement cycle, a maintenance plan, and an asset management technique of the power equipment and its sub-devices.

### BRIEF DESCRIPTION OF THE DRAWINGS

FIG. 1 is a flowchart to explain a method for asset management of power equipment in accordance with one example embodiment of the present invention.

FIG. 2 is a flowchart to explain a method of assessing priorities based on sensitivity of equipment and establishing a maintenance strategy in accordance with one example embodiment of the present invention.

FIG. 3 is a flowchart to minutely explain the method of establishing the maintenance strategy in FIG. 2.

FIG. 4 is a block diagram to explain an internal structure of the asset management apparatus for power equipment in accordance with one example embodiment of the present invention.

FIG. 5 is a graph to explain a process of determining whether to compensate a reference reliability model by sub-device in accordance with one example embodiment of the present invention.

FIG. 6 is an exemplary diagram to explain a process of selecting a maintenance scenario of a GIS in details in accordance with one example embodiment of the present invention.

FIG. 7 is a graph to explain reliability change depending on a maintenance scenario by each sub-device in accordance with one example embodiment of the present invention.

FIGS. 8 and 9 are exemplary diagrams to explain a process of calculating reliability of power equipment by using a failure rate by each sub-device in accordance with one example embodiment of the present invention.

### DETAILED DESCRIPTION OF THE PREFERRED EMBODIMENTS

Detailed example embodiments to implement the present invention will be explained below by referring to attached drawings.

Advantages and/or characteristics of the present invention and a method for achieving them will be clarified by referring to example embodiments described in details with attached drawings. However, the present invention will not be limited to example embodiments below but will be implemented in a variety of forms. The example embodiments herein will complete the commencement of the present invention and will be provided to completely inform those skilled in the art of the scope of the present invention in the technical field to which the present invention belongs and the present invention is just defined by the scope of claims. Same reference signs indicate same components over the whole specification.

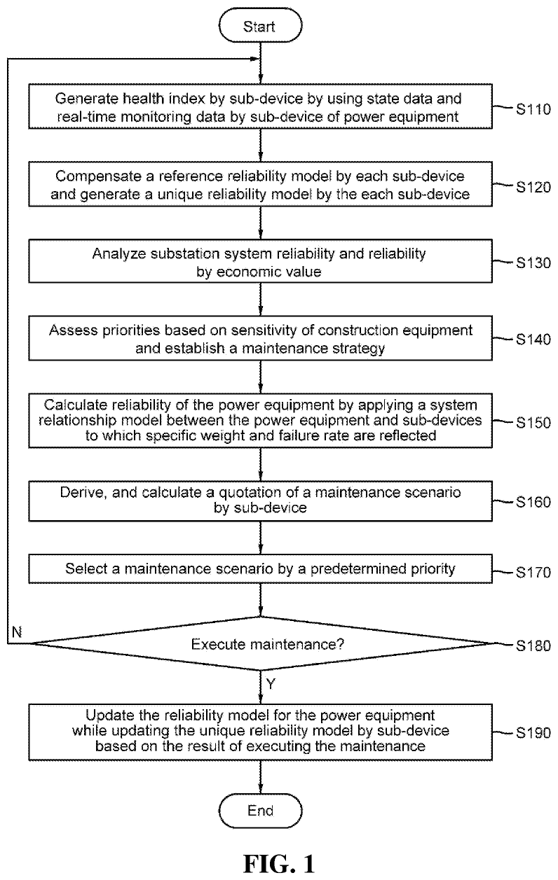

FIG. 1 is a flowchart to explain a method for asset management of power equipment in accordance with one example embodiment of the present invention.

By referring to FIG. 1, an apparatus 100 for asset management of power equipment first generates health index by each sub-device of power equipment by using state data and real-time monitoring data by the each sub-device thereof at S110. At the time, the state data and the real-time monitoring data by the each sub-device of power equipment includes online, offline, and remote monitoring data by the each sub-device. The offline monitoring state data include at least one of data on installation history, inspection history, failure history, an operating environment, and operating history by the each sub-device.

In accordance with one example embodiment of S110, the apparatus for asset management of power equipment may generate total score of, and actions against, technical risks depending on an operating environment, insulation deterioration, an electrical risk, a thermal risk, a chemical risk, a mechanical risk, airtightness performance, insulation performance, interrupting performance, and current-carrying performance by the each sub-device.

For example, the apparatus for asset management of power equipment may generate total score of, and actions against, technical risks depending on an operating environment, insulation deterioration, an electrical risk, a thermal risk, a chemical risk, and a mechanical risk of a transformer or TR by using state data of the TR and information on real-time monitoring thereof.

For another example, the apparatus for asset management of power equipment may generate total score of, and actions against, technical risks depending on operating history data, airtightness performance, insulation performance, interrupting performance, and current-carrying performance of a gas insulated switchgear or GIS by using state data of the GIS and information on real-time monitoring thereof.

Next, the apparatus for asset management of power equipment compensates a reference reliability model by each sub-device and generates a unique reliability model by the each sub-device by comparing reliability of the reference reliability model by the each sub-device and health index by the each sub-device at S120.

Herein, the reference reliability model by the each sub-device is a reference reliability model by the each sub-device generated based on data on installation and inspection history, data on analysis of obsolete and removed items, and data on accelerated life tests by the each sub-device.

At the time, if the health index by the each sub-device is identical to the reliability of the reference reliability model thereby, the apparatus for asset management of power equipment does not compensate the reference reliability model by the each sub-device by determining that the currently used reference reliability model by the each sub-device is an optimal reference reliability model.

In addition, if the health index by the each sub-device is different from the reliability of the reference reliability model thereby, the apparatus for asset management of power equipment compensates the reference reliability model by the each sub-device and generates a unique reliability model by the each sub-device.

In other words, if the health index by the sub-device is different from the reliability of the reference reliability model thereby, the apparatus for asset management of power equipment determines that the currently used reference reliability model by the each sub-device is not an optimal reliability model, and compensates the reference reliability model by the each sub-device by using the health index by the each sub-device, thereby calculating a unique reliability model by the each sub-device.

Through the aforementioned process, the apparatus for asset management of power equipment may optimize the reliability model of the power equipment by compensating the reference reliability model by the each sub-device by the health index thereby, instead of continuously using the reference reliability model by the each sub-device.

Next, the apparatus for asset management of power equipment analyzes substation system reliability and reliability by economic value at S130.

Herein, system reliability is within a certain scope of frequency and voltage, and does not exceed permissible capacities of lines and other equipment. It means the ability of a system that can meet a regulated operational state of a system that satisfies security enough to make the system stabilized securely even at an event of disturbance and that can supply the quantity of electric power a customer requires at the same time. It may be calculated based on energy not supplied (ENS), customer interruption cost (CIC), system failure rate, etc.

The system failure rate may be defined with the sum of failure rates existing on individual loading points as shown in equation 1 below.

$${λ}_{system} ( t ) = {\sum }_{i = 1}^{n} {\sum }_{k = 1}^{m} {λ}_{i \cdot k} ( t ) \qquad [ Equation 1 ]$$

wherein λ_{i.k} refers to a failure rate of equipment k existing at a loading point i.

In addition, the ENS may be defined by multiplying the sum of all loads by the sum of all rates of unavailability caused by equipment existing at loading points.

$$ENS = {\sum }_{i = 1}^{n} {P}_{i} ( t ) {\sum }_{k = 1}^{m} {U}_{i \cdot k} \qquad [ Equation 2 ]$$

wherein Pᵢ is the load of a loading point i; and U_{i.k} means the rate of unavailability caused by equipment k existing at a loading point i.

Meanwhile, customer interruption cost (CIC) may be defined by multiplying, by the sum of all loads, the sum of the values of multiplying a damage cost caused by a power blackout by a failure rate as shown in Equation 3 below.

$$CIC = {\sum }_{i = 1}^{n} {P}_{i} ( t ) {\sum }_{k = 1}^{m} {λ}_{i \cdot k} ( t ) C ( {r}_{i \cdot k} ) \qquad [ Equation 3 ]$$

wherein Pᵢ is the load of a loading point i; λ_{i.k} is a failure rate of equipment k existing at a loading point i; r_{i.k} is a failure recovery time of equipment k existing at a loading point i; and C(r) is a damage cost incurred during r hour(s).

In other words, CIC as the cost of converting into amount, and evaluating, an effect of power blackout on a customer may be divided into an impact cost and a handling cost. The impact cost includes a direct damage cost due to power blackout and an indirect damage cost that gives impact over an economic activity regardless of power blackout and the handling cost is a cost in preparation in advance to minimize the damage by preparing for power blackout expected as a cost in preparation for power interruption or blackout.

Next, the apparatus for asset management of power equipment assesses priorities based on sensitivity of equipment and establishes a maintenance strategy at S140.

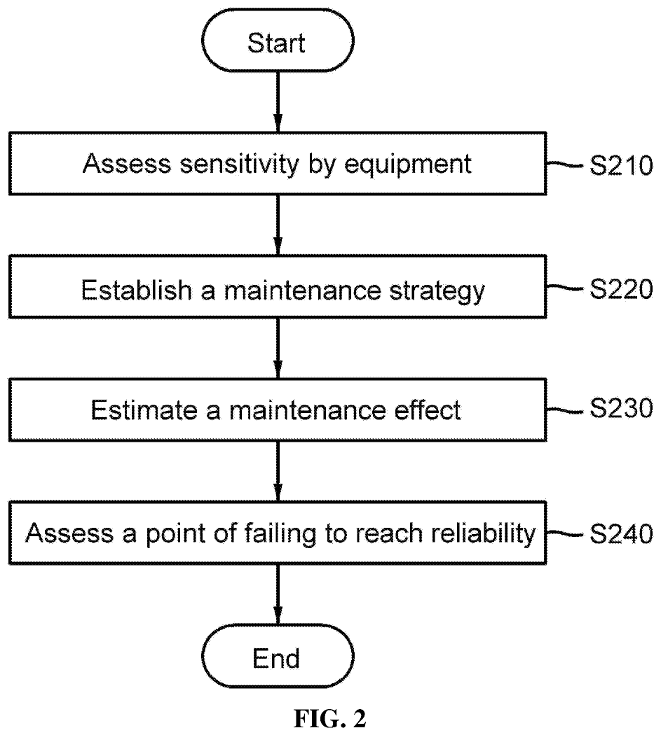

In accordance with one example embodiment, the apparatus for asset management of power equipment performs establishment of a maintenance strategy, estimation of a maintenance effect, assessment of a point of failing to reach reliability while assessing priorities by reflecting input cost efficiency after calculating technical sensitivity and economic sensitivity. The detailed explanation on this will be explained later by referring to FIG. 2.

Next, the apparatus for asset management of power equipment calculates reliability of the power equipment by applying a system relationship model between the power equipment and sub-devices to which specific weight and failure rate are reflected at S150.

In accordance with one example embodiment, the apparatus for asset management of power equipment calculates the failure rates of all sub-devices by applying conditional probability and failure rates to all the sub-devices and sums up the failure rates of all the sub-devices, thereby calculating failure ratio of the power equipment to all the sub-devices. This may be expressed in Equation 4 below.

$${λ}_{assembled} = {\sum }_{i = 1}^{n} {P}_{i} {λ}_{i} \qquad [ Equation 4 ]$$

λ_{assembled}: Failure ratio of power equipment to all of its sub-devices
Pᵢ: Conditional probability by sub-device
λᵢ: Failure rate by sub-device
i: Variable indicating each sub-device

In accordance with another example embodiment, the apparatus for asset management of power equipment calculates failure rates of all sub-devices by applying weight and a failure rate to each of the sub-devices and sums up the failure rates of all the sub-devices, thereby calculating the failure ratio of power equipment to all its sub-devices. This may be expressed in Equation 5 below.

$${λ}_{assembled} = {\sum }_{i = 1}^{n} {ω}_{i} {λ}_{i} \qquad [ Equation 5 ]$$

λ_{assembled}: Failure ratio of power equipment to all of its sub-devices
ωᵢ: Weight by sub-device
λᵢ: Failure rate by sub-device
i: Variable indicating each sub-device

The above example embodiment explains a method for calculating the failure ratio of the power equipment to all the sub-devices by summing up the failure rates of all the sub-devices, but the present invention is not limited to this and a variety of methods may be applied depending on different situations.

Next, the apparatus for asset management of power equipment derives, and calculates a quotation of, a maintenance scenario by the each sub-device at S160.

In accordance with one example embodiment of S160, the apparatus for asset management of power equipment may derive, and calculate a quotation of, a maintenance scenario by sub-device, including a maintenance strategy method, costs, priorities, inspection cycles, estimated costs, inspection scheduling, and assumed maintenance effects by the each sub-device, and expected replacement time thereby, depending on an output value for assessing reliability, that for technical assessment, and that for economic feasibility by the maintenance scenario.

In addition, the apparatus for asset management of power equipment selects a maintenance scenario by a predetermined priority at S170. At the time, the predetermined priority which selects a maintenance scenario may be a priority assessed by reflecting the input cost-efficiency based on the technical sensitivity and the economic sensitivity or be a priority which increases reliability of the power equipment equal to, or higher than, preset reliability or reduces a total maintenance amount equal to, or less than, a specified amount and a variety of priorities may be applied depending on different situations.

Lastly, the apparatus for asset management of power equipment confirms execution of maintenance at S180 and updates the reliability model for the power equipment while updating the unique reliability model by the each sub-device based on the result of executing the maintenance at S190.

FIG. 2 is a flowchart to explain a method of assessing priorities based on sensitivity of equipment and establishing a maintenance strategy in accordance with one example embodiment of the present invention.

As seen in FIG. 2, a method of assessing priorities based on sensitivity of equipment and establishing a maintenance strategy includes a step S210 of assessing sensitivity by equipment, a step S220 of establishing a maintenance strategy, a step S230 of estimating a maintenance effect, and a step of S240 of assessing a point of failing to reach reliability.

First, the step S210 of assessing sensitivity by equipment is assessing an effect of improving reliability upon application of maintenance according to defined inspection type by equipment. At this step, it is possible to calculate technical sensitivity and economic sensitivity and assess priorities based on them.

Herein, sensitivity is calculated by assessing variations of system reliability by changing failure rates of the device while failure rates of any other devices are fixed. It may be divided into technical sensitivity and economic sensitivity.

The technical sensitivity may be defined by combining sensitivity of the system failure rates and sensitivity of the ENS and the economic sensitivity may be defined from the aspect of the CIC.

In short, technical sensitivity (S_{tech}) may be expressed by combining the sensitivity of the system failure rates and the sensitivity of the ENS as shown in Equation 6 below.

S_{tech}=ω_{λ}S_{λ}_{ₗ}+ω_{ENS}S_{ENN}_{ᵢ} [Equation 6]

wherein S_{λ} is the sensitivity of system failure rate; and S_{ENS} is the sensitivity of the ENS.

At the time, as shown in Equation 7 below, the sensitivity of the system failure rate means the sensitivity obtained by dividing difference between failure rate of a system and failure rate of the system when failure rate of one load is changed by the maximum difference therebetween.

$${S}_{{λ}_{i}} = \frac{Δ {λ}_{system \cdot i}}{max ( Δ {λ}_{system} )} = \frac{{λ}_{base system} - {λ}_{modified system \cdot 1}}{max ( Δ {λ}_{system} )} \qquad [ Equation 7 ]$$

In addition, as shown in Equation 8 below, the sensitivity of the ENS means the sensitivity obtained by dividing difference between ENS of a system and ENS of the system when unavailability rate of one load is changed by the maximum difference therebetween.

$${S}_{{ENS}_{i}} = \frac{Δ {ENS}_{system \cdot i}}{max ( Δ {ENS}_{system} )} = \frac{{ENS}_{base system} - {ENS}_{modified system \cdot 1}}{max ( Δ {ENS}_{system} )} \qquad [ Equation 8 ]$$

Besides, as shown in Equation 9 below, economic sensitivity (S_{economic}) means the sensitivity obtained by dividing difference between CIC of a system and CIC of the system when failure rate of one load is changed by the maximum difference therebetween.

$${S}_{{economic}_{i}} = \frac{{Δ CIC}_{system \cdot i}}{max ( Δ {CIC}_{system} )} = \frac{{CIC}_{base system} - {CIC}_{modified system \cdot 1}}{max ( Δ {CIC}_{system} )} \qquad [ Equation 9 ]$$

Meanwhile, it may be necessary to put priorities on equipment inspection, but the technical sensitivity and the economic sensitivity stated above may express only sensitivity from an aspect of the system. Therefore, a priority on equipment inspection in the present invention may be calculated as shown in Equation 10 below by reflecting input cost-efficiency when the maintenance action has been taken.

$${Priority}_{i} = Rank ( \frac{\sqrt{{S}_{{tech}_{i}}^{2} + {S}_{{economic}_{i}}^{2}}}{{Cost}_{{maintenance}_{i}}} ) \qquad [ Equation 10 ]$$

wherein Cost_{maintenance} is an input cost when a maintenance action has been taken.

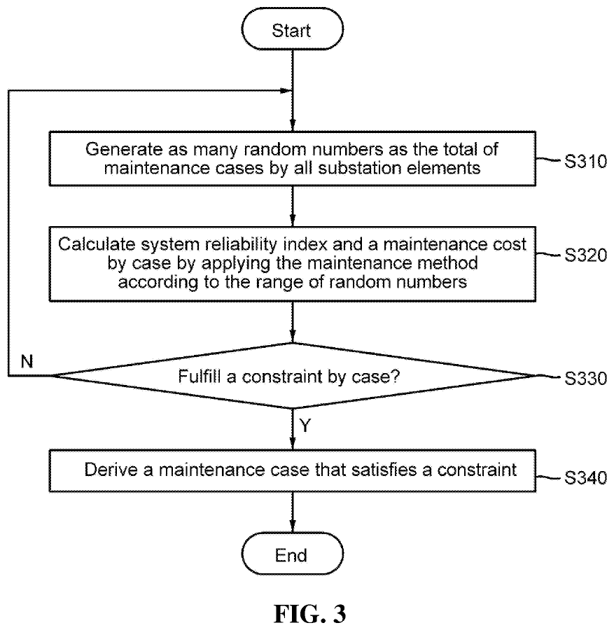

Next, the step S220 of establishing a maintenance strategy is generating as many random numbers as the total of maintenance cases by all substation elements; and calculating system maintenance index and a maintenance cost by applying a maintenance method according to range of random numbers; deriving a maintenance case that satisfies a constraint by determining whether to fulfill the constraint by maintenance case. Detailed explanation on this will be made below by referring to FIG. 3.

Herein, as a constraint by case, a constraint in relation to system reliability index or a maintenance cost may be applied but it is not limited to this.

Since then, the step S230 of estimating a maintenance effect confirms whether maintenance such as normal inspection, precise inspection, replacement, etc. has been performed and estimates the maintenance effect by confirming whether to execute detailed maintenance items, and replacement history in a unit of component, and calculating improvement rate of the result of executing maintenance.

Herein, failure rate models under which improvement rates are applied to a failure rate by the each sub-device are obtained and accumulated. After that, the maintenance effect may be reflected by improving a life model.

Next, the step S240 of assessing a point of failing to reach reliability may derive a point of failing to fulfill a reliability standard for a substation, i.e., a point in time when next maintenance is required. At the time, the point in time when next maintenance is required may be derived by calculating substation reliability index assessed based on a unique reliability model by equipment and calculating a future point of time when a reliability threshold fails to be satisfied. Based on the point of the next maintenance derived, maintenance scheduling and estimation by equipment subject to maintenance are calculated.

FIG. 3 is a flowchart to minutely explain the method of establishing the maintenance strategy in FIG. 2.

As seen in FIG. 3, the method of establishing the maintenance strategy in the present invention includes a step S310 of generating as many random numbers as the total of maintenance cases by all substation elements; a step S320 of calculating system reliability index and a maintenance cost by case by applying the maintenance method according to the range of random numbers; a step S330 of determining whether to fulfill a constraint by case; and a step S340 of deriving a maintenance case that satisfies a constraint.

First, the step S310 of generating as many random numbers as the total of maintenance cases by all substation elements generates as many random numbers as total maintenance cases of all substation elements.

At the time, the random numbers may be generated by Monte Carlo simulation. In addition, while a uniformly distributed random number within range of 0 to 1 is generated, if it is 0 or less as a result of analysis of sensitivity, the random number may be substituted with 0.

Next, at the step S320 of calculating system reliability index and a maintenance cost by case by applying the maintenance method according to the range of random numbers, while the maintenance method according to the range of the random number is applied, the system reliability index and the maintenance cost by case may be calculated.

For example, as shown in Table 1 below, status quo if the random number is 0.25 or less, replacement if the random number is 0.5 or less, precise inspection if the random number is 0.75 or less, and normal inspection if the random number exceeds 0.75 may be applied as a maintenance method.

TABLE 1

| Range of Random Number | Maintenance Method |
|---|---|
| 0~0.25 | Maintenance of status quo |
| 0.25~0.5 | Replacement |
| 0.5~0.75 | Precise inspection |
| 0.75~1 | Normal inspection |

Next, at the step S330 of determining whether to fulfill a constraint by case, a constraint such as system reliability index or a maintenance cost is confirmed and whether to fulfill the constraint by case is determined. As one example of the constraint, system reliability index or a maintenance cost may be applied but it is not limited to this.

Since then, at the step S340 of deriving a maintenance case that satisfies a constraint, a case of fulfilling the constraint is derived.

In the present invention, a maintenance scenario that fulfills conditions such as several types of target reliability or a maintenance cost through the aforementioned method may be selected.

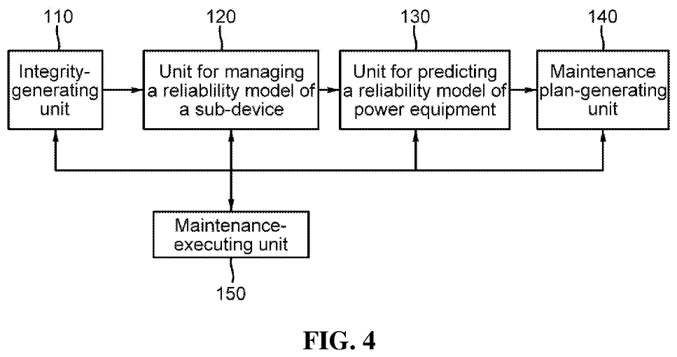

FIG. 4 is a block diagram to explain an internal structure of the apparatus for asset management of power equipment in accordance with one example embodiment of the present invention.

By referring to FIG. 4, the apparatus for asset management of power equipment includes a health index-generating unit 110, a unit 120 for managing a reliability model of a sub-device, a unit 130 for predicting a reliability model of power equipment, a maintenance plan-generating unit 140, and the maintenance plan-executing unit 150.

The health index-generating unit 110 generates health index by each sub-device of the power equipment by using the state data and the real-time monitoring data by the each sub-device. At the time, the state data and the real-time monitoring data by the each sub-device of power equipment include online, offline, and remote monitoring state data by each sub-device. The offline monitoring state data may include at least one of data on installation and inspection history, data on analyses of obsolete and removed items, and data on accelerated life tests by the each sub-device thereof.

In accordance with the present invention, the health index-generating unit 110 may generate total score of, and actions against, technical risks depending on an operating environment, insulation deterioration, an electrical risk, a thermal risk, a chemical risk, a mechanical risk, airtightness performance, insulation performance, interrupting performance, and current-carrying performance by sub-device.

For an example, the health index-generating unit 110 may generate total score of, and actions against, technical risks depending on an operating environment, insulation deterioration, an electrical risk, a thermal risk, a chemical risk, and a mechanical risk of a TR, by using information on a reference reliability model of the TR.

For another example, the health index-generating unit 110 may generate total score of, and actions against, technical risks depending on operating history data, airtightness performance, insulation performance, interrupting performance, and current-carrying performance of a GIS by using a reference reliability model of the GIS.

The unit 120 for managing a reliability model of the sub-device determines whether to compensate the reference reliability model by the each sub-device by comparing the reference reliability model by the each sub-device with health index thereby generated by the health index-generating unit 110. Herein, the reference reliability model by the each sub-device may be generated based on data on installation and inspection history, data on analyses of obsolete and removed items, and data on accelerated life tests by the each sub-device, etc.

At the time, if the health index by the each sub-device is identical to the reliability of the reference reliability model thereby, the unit 120 for managing a reliability model of the sub-device does not compensate the reference reliability model by the each sub-device by determining that the currently used reference reliability model by the each sub-device is an optimal reference reliability model.

In addition, if the health index by the each sub-device is different from the reliability of the reference reliability model thereby, the unit 120 for managing a reliability model of the sub-device generates a unique reliability model by the each sub-device by compensating the reference reliability model thereby.

The aforementioned process may allow the reliability model of the power equipment to be optimized by compensating the reference reliability model by the each sub-device depending on the health index thereby, instead of continuously using the reference reliability model by the each sub-device.

After that, the unit 120 for managing a reliability model of the sub-device analyzes reliability by substation system reliability and economic value.

Herein, as explained above, the system reliability may be calculated with the ENS, the CIC, system failure rate, etc. and the explanation on the system failure rate, the ENS, and the CIC is omitted because they have been already explained above.

Besides, the unit 120 for managing a reliability model of the sub-device accesses priorities based on sensitivity of equipment and establishes a maintenance strategy. At the time, as the method of accessing priorities based on sensitivity of equipment and establishing a maintenance strategy has been already explained, explanation on it is omitted.

The unit 130 for predicting a reliability model of power equipment calculates the reliability of the power equipment by applying a system relationship model between the power equipment and the each sub-device to which specific weight and failure rate are reflected.

After calculating reliabilities of all sub-devices by using reliability by the each sub-device in accordance with one example embodiment, the unit 130 for predicting a reliability model of power equipment calculates the reliability of the power equipment based thereon.

For an example, the unit 130 for predicting a reliability model of power equipment may calculate the failure rates of all sub-devices by applying conditional probability and a failure rate to each sub-device as shown in the Equation 1 above and then the failure rate of the power equipment to all the sub-devices by summing up the failure rates of all the sub-devices.

For another example, the unit 130 for predicting a reliability model of power equipment may calculate the failure rates of all sub-devices by applying weight and failure rate to each sub-device as shown in the Equation 2 above and then calculate the failure ratio of the power equipment to all the sub-devices by summing up the failure rates of all the sub-devices.

In accordance with one example embodiment, the maintenance plan-generating unit 140 may derive, and calculate a quotation of, a maintenance scenario by the each sub-device including a maintenance strategy method, costs, and a priority by each sub-device, inspection cycle, estimated costs, inspection scheduling, and assumed maintenance effects thereby, and expected replacement time thereby depending on an output value for assessing reliability, that for technical assessment, and that for economic feasibility by the maintenance scenario.

As another example embodiment, the maintenance plan-generating unit 140 may establish a maintenance strategy, estimate a maintenance effect, and assess a point of failing to reach reliability while assessing the priorities by reflecting input cost-efficiency after calculating the technical sensitivity and the economic sensitivity.

While selecting a maintenance scenario by the predetermined priority regarding the maintenance scenario and the quotation by each sub-device generated from the maintenance plan-generating unit 140, the maintenance plan-executing unit 150 updates a reliability model for the power equipment while updating the unique reliability model by the each sub-device as a result of executing the maintenance by confirming whether to execute the maintenance.

At the time, the predetermined priority for selecting a maintenance scenario may be a priority assessed by reflecting the input cost-efficiency based on the technical sensitivity and the economic sensitivity as explained above or the predetermined priority applied at the time may be set to increase reliability of power equipment equal to, or higher than, preset reliability or to make a total maintenance cost be equal to, or less than, a specified amount and a variety of priorities may be applied depending on different situations.

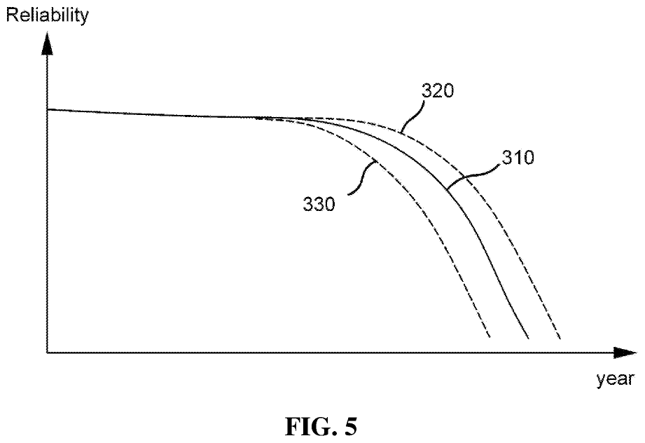

FIG. 5 is a graph to explain a process of determining whether to compensate a reference reliability model by each sub-device in accordance with one example embodiment of the present invention.

By referring to FIG. 5, the apparatus 100 for asset management of power equipment determines whether to compensate the reference reliability model by the each sub-device by comparing reliability 310 of a reference reliability model by the each sub-device with reliability 320, 330 by generated health index by the each sub-device. At the time, as stated above, the reference reliability model by the each sub-device may be generated based on data on installation and inspection history, data on analyses of obsolete and removed items, and data on accelerated life tests by the each sub-device.

Herein, a drawing reference number 320 represents that reliability depending on health index by the each sub-device is a state higher than reliability 310 of a reference reliability model by the each sub-device while a drawing reference number 330 represents that reliability depending on health index by the each sub-device is a state lower than reliability 310 of a reference reliability model by the each sub-device.

In accordance with one example embodiment, if the reliability 310 of the reference reliability model by the each sub-device is different from the reliability 320, 330 depending on the health index thereby generated based on the state data and the real time monitoring data by the each sub-device, the apparatus 100 for asset management of power equipment calculates a unique reliability model by the each sub-device by compensating the reference reliability model by the each sub-device.

In other words, if the reliability 320, 330 depending on the health index by the each sub-device is different from the reliability 310 of the reference reliability model thereby, the apparatus 100 for asset management of power equipment determines that the currently used reference reliability model by each sub-device is not an optimal reference reliability model, compensates the reference reliability model by using the health index by the each sub-device, and then calculates the unique reliability model by the each sub-device.

In accordance with the present invention, it would be possible to derive an optimal reliability model by each sub-device by compensating the reference reliability model by the each sub-device through the aforementioned process.

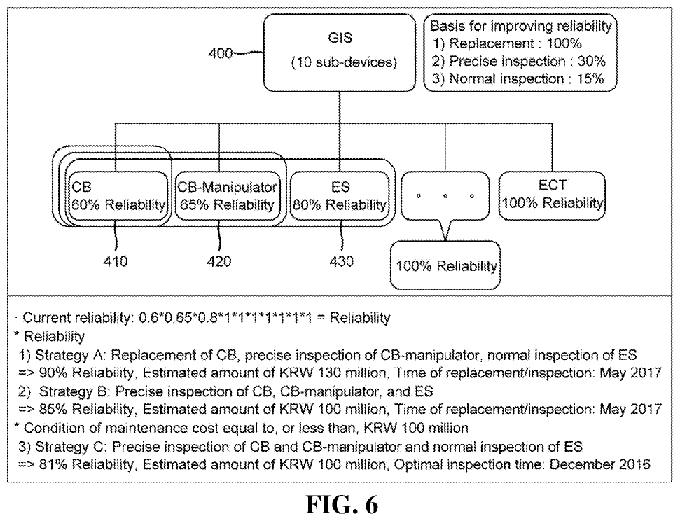

FIG. 6 is an exemplary diagram to explain a process of selecting a maintenance scenario of a GIS in details in accordance with one example embodiment of the present invention.

Below is an explanation on a process for selecting a maintenance scenario with the GIS, as an example in accordance with the present invention.

By referring to FIG. 6, the GIS 400 comprises 10 sub-devices. For example, the sub-devices include a circuit breaker or CB 410 with 60% reliability, a CB manipulator 420 with 65% reliability, an ES430 with 80% reliability, and seven other sub-devices with 100% reliability.

The apparatus for asset management of power equipment draws reliability of the GIS 400 by applying reliability by each sub-device to a system relationship model between the power equipment and sub-devices. To do this, the apparatus for asset management of power equipment calculates the reliability of all the sub-devices and decides the reliability of the power equipment by using the reliability by the each sub-device.

In other words, the apparatus for asset management of power equipment may calculate reliability of all sub-devices by multiplying reliability of each sub-device as 0.6×0.65×0.8×1×1×1×1×1×1×1=38% on assumption that 0.6 for the CB 410, 0.65 for the CB manipulator 420, 0.8 for the ES 430 and 1 for seven sub-devices (1×7) as reliability. Through this, the reliability of the power equipment may be determined to be 38%. Herein, the reliability of each sub-device has been multiplied but the present invention is not limited to this and as explained above, the reliability of all the sub-devices may be also calculated in a method of summing up the reliability of the each sub-device.

Besides, the apparatus for asset management of power equipment may derive a maintenance scenario by each sub-device and may derive maintenance strategies A to C as examples.

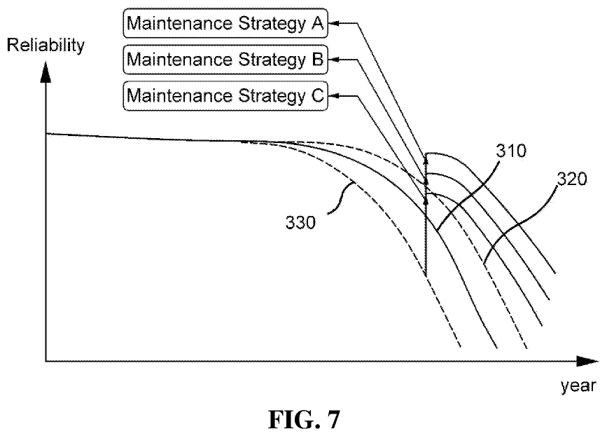

The maintenance methods applied at the time may include replacement of a device, precise inspection, normal inspection and so forth. Through each maintenance method, a basis of improving reliability may be set as 100% for replacement of a device, 30% for precise inspection, and 15% for normal inspection and it is possible to derive a value of improving failure rates depending on the improved reliability. This is illustrated in FIG. 7. FIG. 7 is a graph to explain change in reliability by each maintenance scenario by each sub-device in accordance with one example embodiment of the present invention and the detailed explanation is made below. At the time, the basis of improving the reliability may be changed according to the maintenance of precise inspection and normal inspection depending on the history of actual maintenance carried out.

The maintenance strategy A is a strategy of increasing 0.95×0.95×1×1×1×1×1×1×1×1=90% as reliability of the power equipment based on 100% reliability of the CB 410 through replacement of the CB 410, 95% reliability of the CB manipulator 420 through precise inspection, and 95% reliability of the ES 430 through normal inspection.

The maintenance strategy B is a strategy of increasing 0.95×0.9×0.95×1×1×1×1×1×1×1=85% as reliability of the power equipment based on 90% reliability of the CB 410 through precise inspection, 95% reliability of the CB manipulator 420 through precise inspection, and 100% reliability of the ES 430 through precise inspection.

Meanwhile, the maintenance strategy C is a strategy of increasing 0.9×0.95×0.95×1×1×1×1×1×1×1=81% as reliability of the power equipment based on 90% reliability of the CB 410 through its precise inspection, 95% reliability of the CB manipulator 420 through its precise inspection, and 95% reliability of the ES 430 through its precise inspection.

Since then, the apparatus for asset management of power equipment selects a maintenance scenario by a predetermined priority. As explained above, the predetermined priority applied at the time may be set to increase reliability of power equipment equal to, or higher than, preset reliability or to make a total maintenance cost be equal to, or less than, a specified amount and a variety of priorities may be applied depending on different situations.

FIG. 7 is a graph to explain reliability change by a maintenance scenario by each sub-device in accordance with one example embodiment of the present invention.

In accordance with one example embodiment, the basis of improving reliability may be set differently depending on each maintenance method. A maintenance method may be set to be 100% for replacement of a device, 30% for precise inspection, and 15% for normal inspection but reliability by maintenance respectively through precise inspection and through normal inspection may be changed depending on the history of actual maintenance carried out.

In FIG. 7, it can be found out that the maintenance strategy A determined through a process of FIG. 6, as a maintenance scenario including replacement of the device, has the most greatly improved reliability while the maintenance strategy B, as a precise inspection-centered maintenance scenario, has the moderately improved reliability.

Meanwhile, it can be found out that the maintenance strategy C determined through a process of FIG. 6, a maintenance scenario to which normal inspection is applied, shows the least greatly improved reliability.

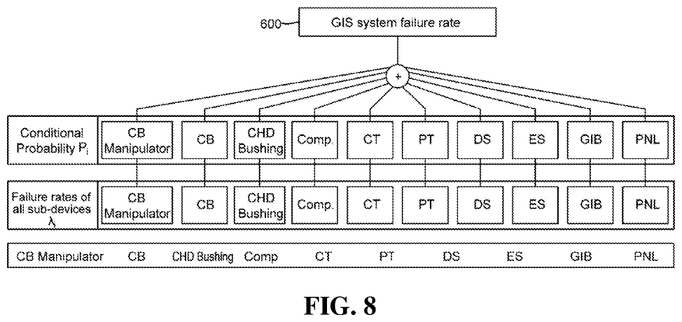

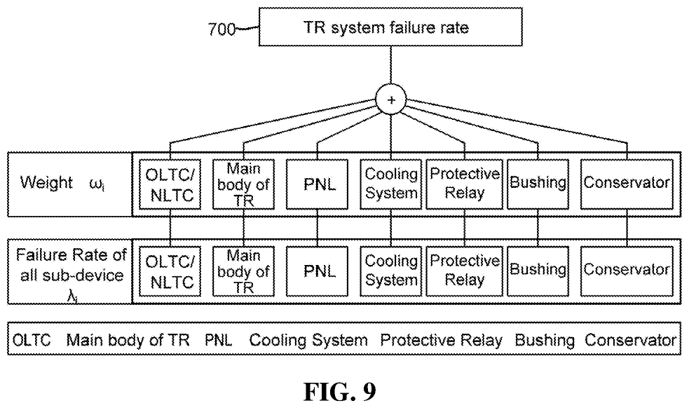

FIGS. 8 and 9 are exemplary diagrams to explain a process of calculating reliability of power equipment by using a failure rate by each sub-device in accordance with one example embodiment of the present invention.

By referring to FIGS. 8 and 9, the apparatus for asset management of power equipment derives the failure rate of the power equipment by applying the failure rate by the each sub-device to the system relationship model between the power equipment and its sub-devices.

In accordance with one example embodiment, the apparatus for asset management of power equipment may calculate the failure rates of all sub-devices by applying conditional probability P and a failure rate λ to each sub-device to determine the reliability of the power equipment to all the sub-devices. For example, as shown in FIG. 8, the apparatus for asset management of power equipment may calculate the failure rates of all sub-devices by applying conditional provability P and failure rate λ to sub-devices, i.e., a CB manipulator, a CB, CHD bushing, Comp., CT, PT, DS, ES, GIB, and PNL of a GIS 600 to determine reliability of the GIS 600 to all the sub-devices.

In accordance with another example embodiment, the apparatus for asset management of power equipment may calculate the failure rates of all the sub-devices by applying weight w and failure rate λ to each sub-device to determine reliability of the power equipment to all the sub-devices.

For example, as shown in FIG. 9, the apparatus for asset management of power equipment may calculate the failure rate of all the sub-devices by applying weight w and failure rate λ to all sub-devices of a transformer 700, including an OLTC, an NLTC, a main body of the TR, a PNL, a cooling system, a protective relay, bushing and a conservator, to determine reliability of the power equipment to all the sub-devices.

As shown above, the present invention is explained by limited example embodiments and drawings but it is not limited to the example embodiments. Various changes and modifications may be derived from those skilled in the art. Accordingly, the invention must be identified by the claims of the present invention as described below and all variables and equivalents would appertain to the scope of the ideas of the present invention.

### * REFERENCE NUMERALS

100: Apparatus for asset management of power equipment

110: Health index-generating unit

120: Unit for managing a reliability model of a sub-device

130: Unit for predicting a reliability model of power equipment

140: Maintenance plan-generating unit

150: Maintenance-executing unit

### INDUSTRIAL AVAILABILITY

The present invention relates to a method for asset management of power equipment and an apparatus for executing this and it is available in a field of power equipment.

What is claimed is:

1. A method for asset management of power equipment, comprising steps of:
generating health index of each sub-device of the power equipment by using state data and real-time monitoring data of the each sub-device;
compensating a reference reliability model by the each sub-device and generating a unique reliability model by the each sub-device by comparing reliability of the reference reliability model by the each sub-device and the health index by the each sub-device;
analyzing reliability by substation system reliability and reliability by economic value;
assessing priorities based on equipment sensitivity and establishing a maintenance strategy;
calculating reliability of the power equipment by applying a system relationship model between the power equipment and the each sub-device to which specific weight and failure rate are reflected;
deriving, and calculating a quotation of, a maintenance scenario by the each sub-device; and
updating the reliability model for the power equipment while updating the unique reliability model by the each sub-device by selecting a maintenance scenario by a predetermined priority and as a result of executing the maintenance.

2. The method of claim 1, wherein the step of assessing priorities based on equipment sensitivity and establishing a maintenance strategy includes steps of: calculating technical sensitivity and economic sensitivity and assessing sensitivity by equipment that assesses priorities based on the calculation; establishing a maintenance strategy for deriving an optimal maintenance strategy among various maintenance strategies; confirming whether to execute maintenance and estimating a maintenance effect of calculating improvement rate according to the result of executing the maintenance; and assessing a point in time of failing to reach reliability to draw a point in time when next maintenance is required due to failing to meet a reliability standard.

3. The method of claim 2, wherein the technical sensitivity includes sensitivity of system failure rate and sensitivity of energy not supplied or ENS; wherein the sensitivity of the system failure rate means sensitivity obtained by dividing difference between failure rate of a system and failure rate of the system when failure rate of one load is changed by the maximum difference therebetween; and wherein the sensitivity of the ENS means the sensitivity obtained by dividing difference between ENS of a system and ENS of the system when unavailability rate of one load is changed by the maximum difference therebetween.

4. The method of claim 2, wherein the economic sensitivity means the sensitivity obtained by dividing difference between CIC of a system and CIS of the system when failure rate of one load is changed by the maximum difference therebetween.

5. The method of claim 2, wherein the priorities are determined by reflecting an improvement effect to the input cost when the maintenance action has been taken based on the technical sensitivity and the economic sensitivity.

6. The method of claim 2, wherein the step of establishing a maintenance strategy is calculating system reliability index and a maintenance cost by each maintenance case by each of all elements of a substation, determining whether to meet constraints by the each maintenance case, deriving the each maintenance case satisfying the constraint, thereby establishing a strategy.

7. The method of claim 2, wherein the step of assessing a point in time of failing to reach reliability is drawing a point in time when next maintenance is required by calculating the assessed reliability index of the substation based on a unique reliability model by the each sub-device and a future point in time that fails to satisfy a reliability threshold.

8. The method of claim 1, wherein the reference reliability model by the each sub-device is generated based on at least one of data on installation and inspection history by the sub-device, analysis of obsolete and removed items, and accelerated life test.

9. The method of claim 1, wherein the step of generating health index of each sub-device of the power equipment by using state data and real-time monitoring data of the each sub-device includes a step of generating health index by the each sub-device by using online, offline, and remote monitoring state data by the each sub-device; wherein the offline monitoring state data includes at least one of data on installation history, inspection history, failure history, operating environment, and operation history by the each sub-device.

10. The method of claim 1, wherein the step of generating health index of each sub-device of the power equipment by using state data and real-time monitoring data of the each sub-device includes a step of generating total score of, and actions against, technical risks depending on an operating environment, insulation deterioration, an electrical risk, a thermal risk, a chemical risk and a mechanical risk, airtightness performance, insulation performance, interrupting performance, and current-carrying performance by the each sub-device.

11. The method of claim 1, wherein the step of compensating a reference reliability model by the each sub-device and generating a unique reliability model by the each sub-device by comparing reliability of the reference reliability model by the each sub-device and the health index by the each sub-device includes a step of compensating the reference reliability model by the each sub-device and calculating the reliability by applying the health index by the each sub-device.

12. The method of claim 1, wherein the step of calculating reliability of the power equipment by applying a system relationship model between the power equipment and the each sub-device to which specific weight and failure rate are reflected includes a step of calculating failure rate of the power equipment by applying the specific weight and the specific failure rate to the each sub-device.

13. The method of claim 1, wherein the step of deriving, and calculating a quotation of, a maintenance scenario by the each sub-device includes a step of deriving, and calculating a quotation of, a maintenance scenario by sub-device, including a maintenance strategy method, costs, and priority by the each sub-device, inspection cycles, estimated costs, inspection scheduling, and assumed maintenance effects thereby, and expected replacement time thereby, depending on an output value for assessing reliability, that for technical assessment, and that for economic feasibility by the maintenance scenario.

14. The method of claim 1, wherein the step of selecting a maintenance scenario by the predetermined priority is using priorities assessed by reflecting an improvement effect to the input cost based on the technical sensitivity and the economic sensitivity.

15. The method of claim 1, wherein the step of selecting a maintenance scenario by the predetermined priority is selecting a maintenance scenario by the each sub-device under which the reliability of the power equipment exceeds a specific reliability.

16. The method of claim 1, wherein the step of selecting a maintenance scenario by the predetermined priority is selecting a maintenance scenario by the each sub-device of the power equipment to make the whole maintenance cost less than specified amount.

17. The method of claim 1, wherein the constraint includes at least one of conditions related to the system reliability index or the maintenance cost.
